(19) United States
(12) Patent Application Publication
(10) Pub. No.: US 2016/0067929 A1
(43) Pub. Date: Mar. 10, 2016

(54) APPARATUS FOR FABRICATING THREE-DIMENSIONAL OBJECT

(71) Applicant: Soyoung Park, Kanagawa (JP)

(72) Inventor: Soyoung Park, Kanagawa (JP)

(73) Assignee: RICOH COMPANY, LTD., Tokyo (JP)

(21) Appl. No.: 14/847,135

(22) Filed: Sep. 8, 2015

(30) Foreign Application Priority Data
Sep. 9, 2014 (JP) 2014-183004
Jul. 8, 2015 (JP) 2015-137218

(51) Int. Cl. B29C 67/00; B28B 1/00; B27N 5/00; B22F 3/105

(52) U.S. Cl. CPC B29C 67/0096; B22F 3/1055; B28B 1/001; B27N 5/00; B29C 67/0077; B33Y 30/00

(57) ABSTRACT

A three-dimensional fabricating apparatus includes a fabrication stage, a rotator, a powder remover, and a cleaning controller. Fabrication layers including powder bonded together are to be laminated on the fabrication stage. The rotator rotates and moves relatively with respect to the fabrication stage in a direction along a stage surface of the fabrication stage to flatten a surface of the powder on the fabrication stage and form a powder layer. The powder remover contacts a circumferential surface of the rotator and removes the powder adhering to the circumferential surface of the rotator. The cleaning controller is operatively connected to the rotator to control a cleaning operation to rotate the rotator and clean the powder accumulated between the circumferential surface of the rotator and the powder remover.

### CROSS-REFERENCE TO RELATED APPLICATIONS

This patent application is based on and claims priority pursuant to 35 U.S.C. §119(a) to Japanese Patent Application Nos. 2014-183004, filed on Sep. 9, 2014, and 2015-137218, filed on Jul. 8, 2015, in the Japan Patent Office, the entire disclosure of each of which is hereby incorporated by reference herein.

### BACKGROUND

1. Technical Field

Aspects of the present disclosure relate to an apparatus for fabricating a three-dimensional object.

2. Description of the Related Art

As a solid (three-dimensional) fabricating apparatus to fabricate a solid (three-dimensional) object, for example, a lamination fabrication method is known. In this method, for example, a flattened metal or non-metal powder layer is formed on a fabrication stage, and fabrication liquid is discharged from a head to the powder layer on the fabrication stage to form a thin fabrication layer in which powders are bonded together. A step of forming another powder layer on the fabrication layer to reform the fabrication layer is repeated to laminate the fabrication layers, thus producing a three-dimensional object.

### SUMMARY

In an aspect of this disclosure, there is provided a three-dimensional fabricating apparatus including a fabrication stage, a rotator, a powder remover, and a cleaning controller. Fabrication layers including powder bonded together are to be laminated on the fabrication stage. The rotator rotates and moves relatively with respect to the fabrication stage in a direction along a stage surface of the fabrication stage to flatten a surface of the powder on the fabrication stage and form a powder layer. The powder remover contacts a circumferential surface of the rotator and removes the powder adhering to the circumferential surface of the rotator. The cleaning controller is operatively connected to the rotator to control a cleaning operation to rotate the rotator and clean the powder accumulated between the circumferential surface of the rotator and the powder remover.

In an aspect of this disclosure, there is provided a three-dimensional fabricating apparatus including a fabrication stage, a rotator, a powder remover, a suction device, and a cleaning controller. Fabrication layers including powder bonded together are to be laminated on the fabrication stage. The rotator rotates and moves relatively with respect to the fabrication stage in a direction along a stage surface of the fabrication stage to flatten a surface of the powder on the fabrication stage and form a powder layer. The powder remover contacts a circumferential surface of the rotator and removes the powder adhering to the circumferential surface of the rotator. The suction device sucks the powder accumulated between the circumferential surface of the rotator and the powder remover. The cleaning controller is operatively connected to the suction device to control a cleaning operation to suck the powder with the suction device.

In an aspect of this disclosure, there is provided a three-dimensional fabricating apparatus including a fabrication stage, a rotator, a powder remover, and a cleaning controller. Fabrication layers including powder bonded together are to be laminated on the fabrication stage. The rotator rotates and moves relatively with respect to the fabrication stage in a direction along a stage surface of the fabrication stage to flatten a surface of the powder on the fabrication stage and form a powder layer. The powder remover contacts a circumferential surface of the rotator and removes the powder adhering to the circumferential surface of the rotator. The powder remover is contactable with and separatable from the circumferential surface of the rotator and includes a cleaner to remove the powder adhering to the circumferential surface of the rotator. The cleaning controller is operatively connected to the powder remover to control a cleaning operation to remove the powder adhering to the circumferential surface of the rotator with the cleaner in a state in which the powder remover is separated from the circumferential surface of the rotator.

### BRIEF DESCRIPTION OF THE SEVERAL VIEWS OF THE DRAWINGS

The aforementioned and other aspects, features, and advantages of the present disclosure would be better understood by reference to the following detailed description when considered in connection with the accompanying drawings, wherein:

FIG. 1 is a partial perspective view of an example of a three-dimensional fabricating apparatus according to the present disclosure;

FIG. 2 is a schematic side view of the three-dimensional fabricating apparatus of FIG. 1;

FIG. 3 is a perspective view of an example of a powder chamber of a fabrication section;

FIG. 4 is a schematic cross-sectional view of the fabrication section of FIG. 3;

FIG. 5 is a block diagram of a controller of the three-dimensional fabricating apparatus;

FIGS. 6A through 6D are schematic cross-sectional views of a fabrication section at fabrication steps;

FIGS. 7A through 7D are schematic cross-sectional views of the fabrication section at fabrication steps subsequent to the steps of FIGS. 6A through 6D;

FIGS. 8A and 8B are illustrations of an example of reduction in flatness of a powder layer due to falling of aggregated powder in a densification step or a flattening step;

FIGS. 9A through 9D are schematic cross-sectional views of a fabrication section at fabrication steps in a first embodiment of the present disclosure;

FIGS. 10A through 10D are schematic cross-sectional views of the fabrication section at fabrication steps subsequent to the steps of FIGS. 9A through 9D;

FIG. 11 is a flowchart of a fabrication process controlled by a main controller in a second exemplary embodiment;

FIG. 12 is a schematic cross-sectional view of cleaning operation of a fabrication section in a third embodiment;

FIG. 13 is a perspective view of a portion of the fabrication section of FIG. 12; FIG. 14 is a schematic cross-sectional view of cleaning operation of a fabrication section in a fourth embodiment;

FIG. 15 is a schematic cross-sectional view of cleaning operation of a fabrication section in a fourth embodiment; and

FIG. 16 is a perspective view of a powder chamber in a sixth embodiment.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

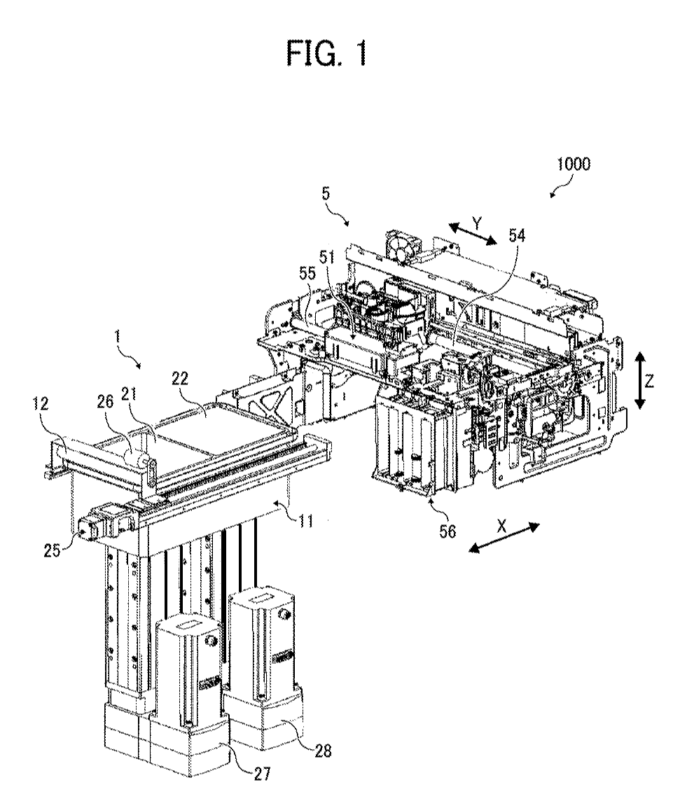

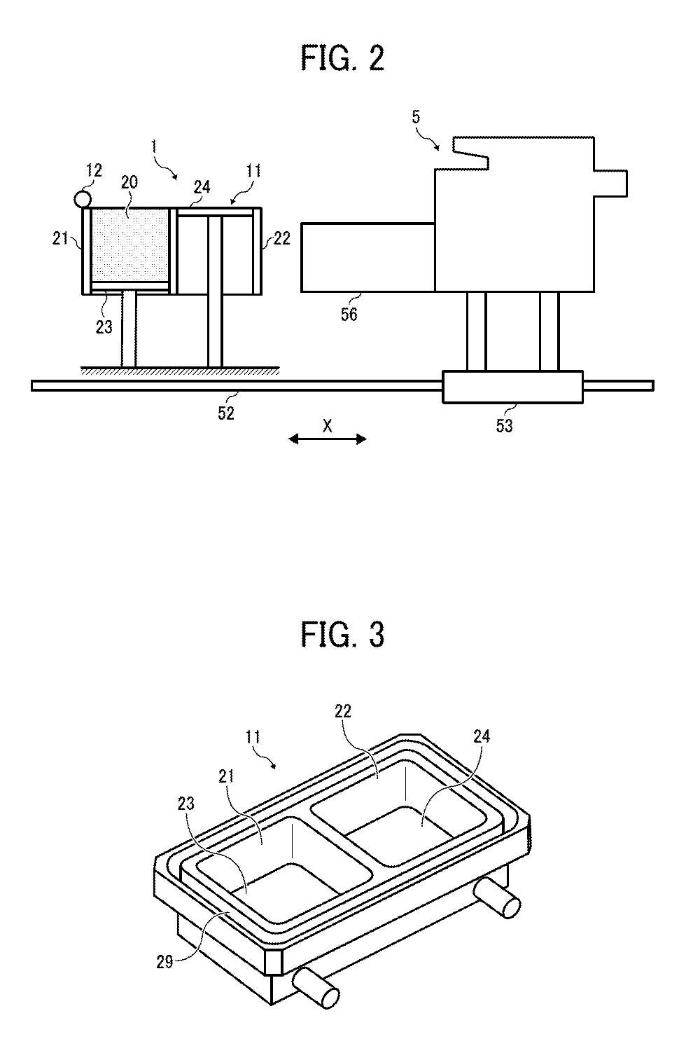

Hereinafter, embodiments of the present disclosure are described with reference to the attached drawings. First, an example of a three-dimensional fabricating apparatus according to this disclosure is described with reference to FIGS. 1 and 2. FIG. 1 is a partial perspective view of a three-dimensional fabricating apparatus 1000 according to an embodiment of this disclosure. FIG. 2 is a schematic side view of the three-dimensional fabricating apparatus 1000.

The three-dimensional fabricating apparatus 1000 includes a fabrication section 1 and a fabrication unit 5. The fabrication section 1 forms a fabrication layer in which powders are bonded together. The fabrication unit 5 fabricates a three-dimensional object by discharging fabrication.

The fabrication section 1 includes a powder chamber 11 and a flattening roller (also referred to as recoater roller) 12 that is a rotator serving as a flattening unit.

The powder chamber 11 includes a supply chamber 21 to supply powder 20 and a fabrication chamber 22 to fabricate an object. A bottom portion of the supply chamber 21 serves as a supply stage 23 and is movable upward and downward in a vertical direction (height direction). Similarly, a bottom portion of the fabrication chamber 22 serves as a fabrication stage 24 and is movable upward and downward in the vertical direction (height direction). A three-dimensional object is fabricated on the fabrication stage 24.

A motor 27 moves the supply stage 23 upward and downward. A motor 28 moves the fabrication stage 24 upward and downward.

The flattening roller 12 supplies the powder 20 supplied on the supply stage 23 of the supply chamber 21, to the fabrication chamber 22 and flattens the powder 20 to form a powder layer. With a reciprocal moving assembly 25, the flattening roller 12 is movable relatively reciprocally with respect to a stage surface (a surface on which powder 20 is stacked) of the fabrication stage 24 in a direction indicated by arrow X in FIG. 2, which is a direction along the stage surface of the fabrication stage 24, and a motor 26 drives and rotates the flattening roller 12.

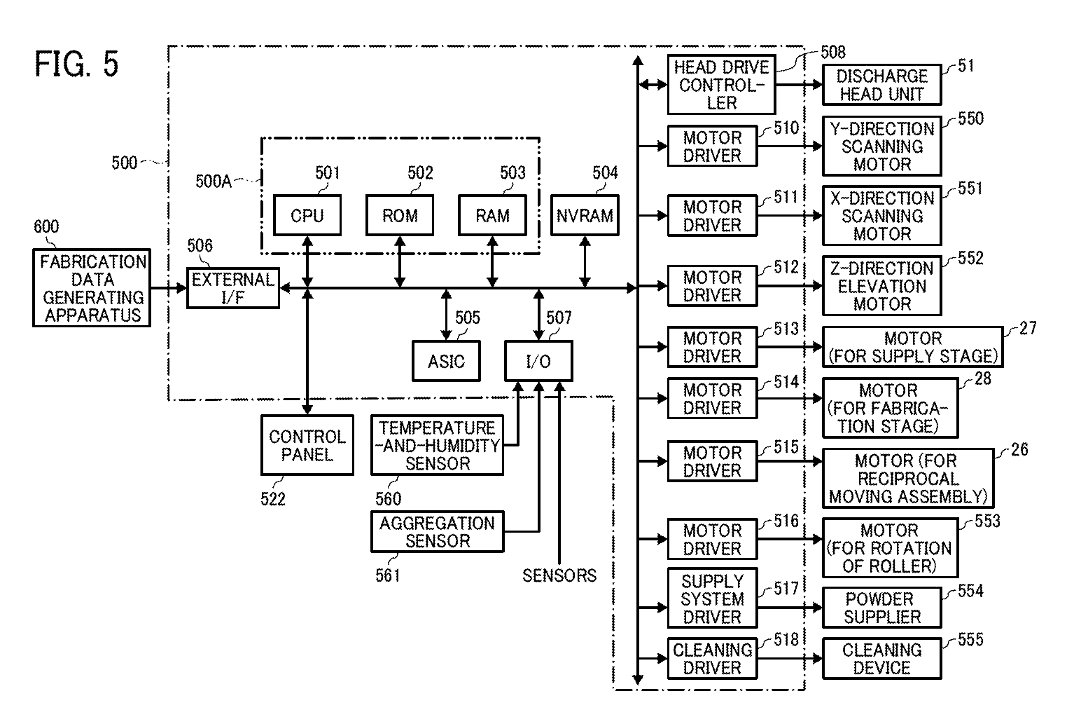

The fabrication unit 5 includes a discharge head unit 51 including liquid discharge heads to discharge fabrication liquid to the powder layer on the fabrication stage 24. The fabrication unit 5 further includes a head cleaning assembly (e.g., a cleaning device 555 in FIG. 5) to clean the discharge head unit 51.

The head cleaning assembly (device) includes caps and a wiper. The caps are brought into close contact with nozzle faces at the lower side of the heads, and fabrication liquid is sucked from nozzles. Thus, powder clogged at the nozzles and thickened fabrication liquid are discharged. Then, a wiper wipes the nozzle faces to form menisci in the nozzles (with the interiors of the nozzles being in a negative pressure state). When fabrication liquid is not discharged, the head cleaning assembly covers the nozzle faces of the heads to prevent incorporation of powder into nozzles and drying of fabrication liquid. The fabrication unit 5 includes a slider 53 movably supported by a guide 52, and the entire fabrication unit 5 is reciprocally movable in the direction indicated by arrow X. A scanning assembly including a motor 551 reciprocally moves the entire fabrication unit 5 along the direction indicated by arrow X.

The discharge head unit 51 is supported by guides 54 and 55 so as to be reciprocally movable along a direction indicated by arrow Y. A scanning assembly including a motor 550 reciprocally moves the discharge head unit 51 in the direction indicated by arrow Y.

The discharge head unit 51 is supported so as to be movable upward and downward along a direction indicated by arrow Z together with the guides 54 and 55. A scanning assembly including a motor 552 moves the discharge head unit 51 upward and downward in the direction indicated by arrow Z.

The discharge head unit 51 includes, e.g., a head to discharge a cyan fabrication liquid, a head to discharge a magenta fabrication liquid, a head to discharge an yellow fabrication liquid, a head to discharge a black fabrication liquid, and a head to discharge a colorless fabrication liquid. A tank mount 56 mounts plural tanks containing cyan fabrication liquid, magenta fabrication liquid, yellow fabrication liquid, black fabrication liquid, and colorless fabrication liquid.

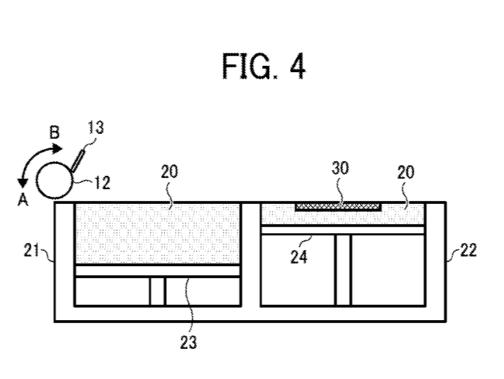

Next, an example of the fabrication unit is described with reference to FIG. 3 and FIG. 4. FIG. 3 is a perspective view of an example of the powder chamber. FIG. 4 is a schematic cross-sectional view of an example of the fabrication unit.

The powder chamber 11 has a box shape and includes two chambers, the supply chamber 21 and the fabrication chamber 22, each of which is open at the upper side thereof. The supply stage 23 and the fabrication stage 24 are arranged inside the supply chamber 21 and the fabrication chamber 22, respectively, so as to be movable upward and downward.

Lateral faces of the supply stage 23 are disposed to contact inner lateral faces of the supply chamber 21. Lateral faces of the fabrication stage 24 are disposed to contact inner lateral faces of the fabrication chamber 22. The upper faces of the supply stage 23 and the fabrication stage 24 are held horizontally.

As illustrated in FIG. 3, a powder falling groove 29 is disposed at the periphery of the powder chamber 11 and has a recessed shape with the upper side thereof being open. Excessive powder 20 collected with the flattening roller 12 in formation of a powder layer falls to the powder falling groove 29. Excessive powder 20 having fallen to the powder falling groove 29 is returned to a powder supply section that supplies powder to the supply chamber 21.

A powder supplier (e.g., a powder supplier 554 in FIG. 5 serving as a powder supply unit) has, e.g., a tank shape and is disposed above the supply chamber 21. In an initializing operation of fabrication or when the amount of powder in the supply chamber 21 decreases, powder in the tank is supplied to the supply chamber 21. Examples of a powder transporting method for supplying powder include a screw conveyor method utilizing a screw and an air transport method utilizing air.

The flattening roller 12 transfers and supplies powder 20 from the supply chamber 21 to the fabrication chamber 22 and forms a desired thickness of powder layer.

The flattening roller 12 is a bar longer than an inside dimension of the fabrication chamber 22 and the supply chamber 21 (that is, a width of a portion to which powder is supplied or stored). The reciprocal moving assembly 25 reciprocally moves the flattening roller 12 in a direction along the stage surface (the direction indicated by arrow X parallel to the stage surface).

While being rotated by a motor 26, the flattening roller 12 horizontally moves to pass an area above the supply chamber 21 and the fabrication chamber 22 from the outside of the supply chamber 21, thus transferring and supplying the powder 20 onto the fabrication chamber 22.

As illustrated in FIG. 4, a powder removal plate 13 serving as a powder remover to remove the powder 20 attached to the flattening roller 12 is disposed in contact with a circumferential surface of the flattening roller 12.

The powder removal plate 13 moves together with the flattening roller 12 in contact with the circumferential surface of the flattening roller 12. The powder removal plate 13 is arranged in a state in which the powder removal plate 13 counters the flattening roller 12 when the flattening roller 12 rotates in a direction indicated by arrow A in FIG. 4 (a direction in which the flattening roller 12 rotates to flatten the powder 20).

The rotation of the flattening roller 12 in a direction indicated by arrow B in FIG. 4 is referred to as “forward direction” which is a direction in which the rotator rotates to flatten powder). By contrast, the rotation of the flattening roller 12 in the direction indicated by arrow A in FIG. 4 is referred to as “reverse direction” which is a direction opposite the direction in which the rotator rotates to flatten powder).

In this embodiment, the powder chamber 11 of the fabrication section 1 includes two chambers, i.e., the supply chamber 21 and the fabrication chamber 22. In some embodiments, a powder chamber includes only the fabrication chamber 22, and a powder supplier supplies powder to the fabrication chamber 22 and the flattening unit flattens the powder.

Next, an outline of a controller of the three-dimensional fabricating apparatus is described with reference to FIG. 5. FIG. 5 is a block diagram of a controller of the three-dimensional fabricating apparatus according to an embodiment of this disclosure.

A controller 500 serving as the controller includes a main controller 500A. The main controller 500A includes a central processing unit (CPU) 501, a read-only memory (ROM) 502, a random access memory (RAM) 503, a non-volatile random access memory (NVRAM) 504, and an application-specific integrated circuit (ASIC) 505. The CPU 501 manages the control of the entire three-dimensional fabricating apparatus 1000. The ROM 502 stores programs executed by the CPU 501 and other fixed data. The RAM 503 temporarily stores image data (print data) and other data.

The NVRAM 504 retains data even when the apparatus is powered off. The ASIC 505 performs image processing, such as processing of various signals on image data, and processes input and output signals to control the entire apparatus.

The controller 500 also includes an external interface (I/F) 506 to send and receive data and signals used in receiving fabrication data from an external fabrication data generating apparatus 600. The fabrication data generating apparatus 600 generates fabrication data in which a final-form object is sliced in multiple fabrication layers, and is constituted of an information processing apparatus, such as a personal computer.

The controller 500 includes an input-output (I/O) unit to receive detection signals of various sensors.

The controller 500 includes a head drive controller 508 to control driving of each head of the discharge head unit 51.

The controller 500 includes a motor driver 510 and a motor driver 511. The motor driver 510 drives a Y-direction scanning motor 550 to move the discharge head unit 51 in the direction indicated by arrow Y. The motor driver 511 drives an X-direction scanning motor 551 to move the fabrication unit 5 in the direction indicated by arrow X.

The controller 500 includes a motor driver 512 to drive a Z-direction elevation motor 552 to move (elevate) the discharge head unit 51 upward and downward in a direction indicated by arrow Z. Note that, instead of the discharge head unit 51, the fabrication unit 5 may be elevated in the direction indicated by arrow Z.

The controller 500 includes a motor driver 513 and a motor driver 514. The motor driver 513 drives the motor 27 to elevate the supply stage 23 upward and downward. The motor driver 514 drives the motor 28 to elevate the fabrication stage 24 upward and downward.

The controller 500 includes a motor driver 515 and a motor driver 516. The motor driver 515 drives the motor 26 of the reciprocal moving assembly 25 to move the flattening roller 12. The motor driver 516 includes a motor 553 to rotate the flattening roller 12.

The controller 500 includes a supply system driver 517 and a cleaning driver 518. The supply system driver 517 drives the power supplier 554 to supply powder 20 to the supply chamber 21. The cleaning driver 518 drives a cleaning device 555 to perform cleaning (maintenance, maintenance-and-recovery) on the discharge head unit 51. The I/O unit 507 receives detection signals from a temperature-and-humidity sensor 560 to detect temperature and humidity as environmental conditions and other sensors. The I/O unit 507 receives detection signals from an aggregation sensor 561 to detect powder accumulated between the flattening roller 12 and powder removal plate 13 and detection signals of the amount of powder remaining in the supply chamber 21.

The controller 500 is connected to a control panel 522 for inputting and displaying information necessary to the three-dimensional fabricating apparatus 1000.

The main controller 500A also serves as a cleaning controller according to an embodiment of this disclosure. The main controller 500A controls cleaning operation to rotate the flattening roller 12 and clean powder 20 accumulated between a circumferential surface of the flattening roller 12 and the powder removal plate 13.

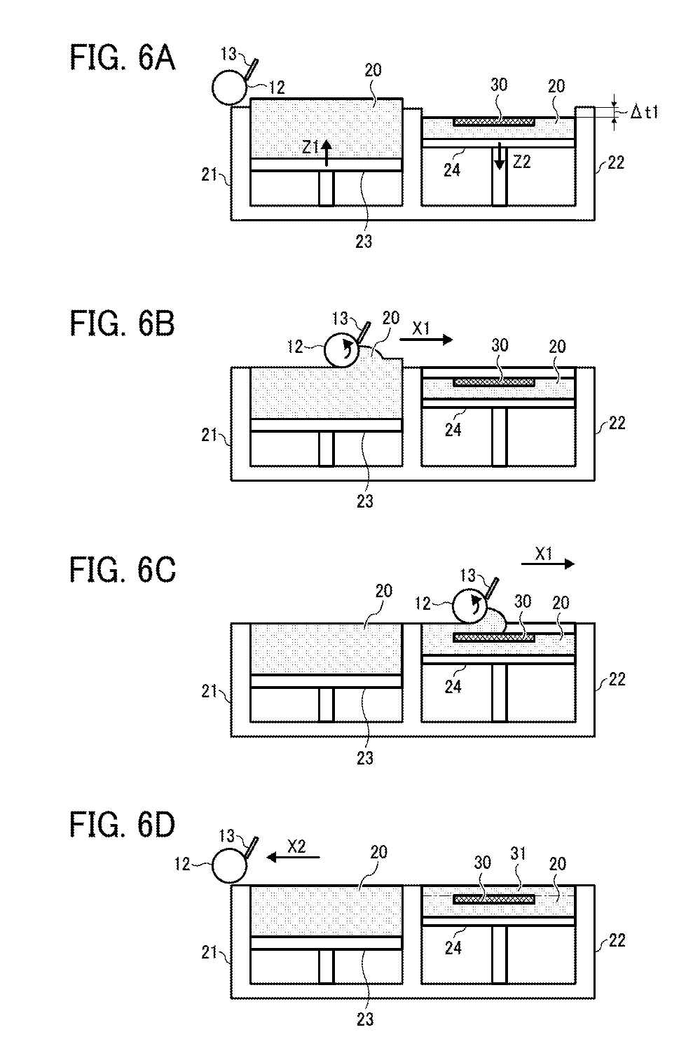

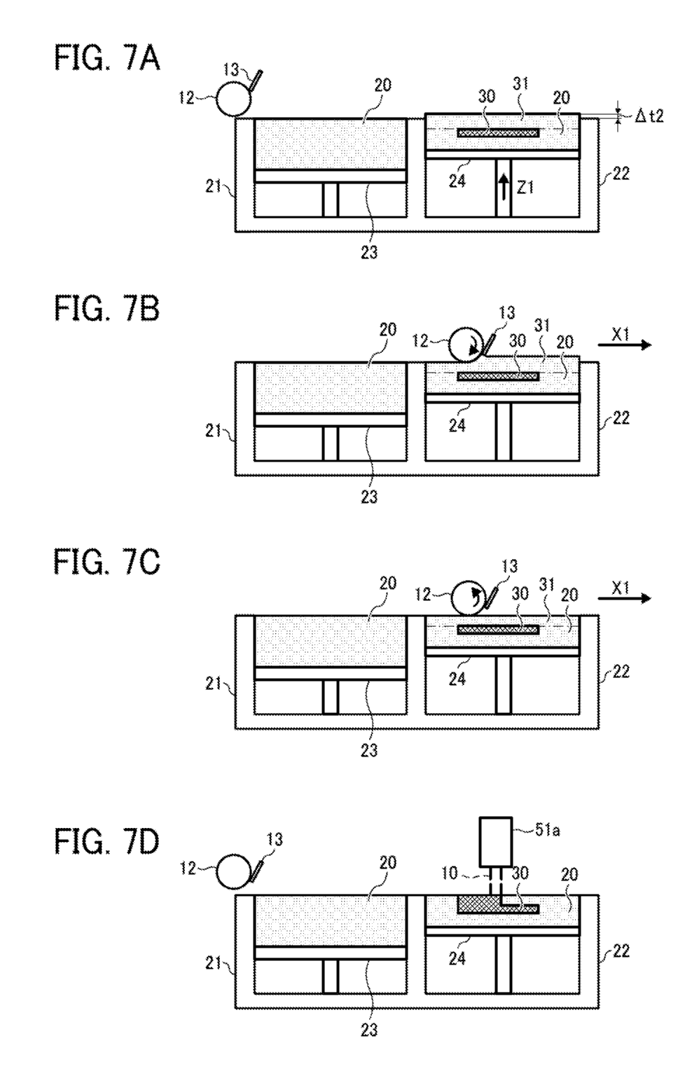

Next, a flow of fabrication is described with reference to FIGS. 6A through 6D and 7A through 7D. FIGS. 6A through 6D are schematic cross-sectional views of fabrication steps of the fabrication section according to an embodiment of this disclosure.

As illustrated in FIG. 4, for example, a first fabrication layer 30 is formed on the fabrication stage 24 of the fabrication chamber 22.

When a second fabrication layer 30 is formed on the first fabrication layer 30, as illustrated in FIG. 6A, the supply stage 23 of the supply chamber 21 moves upward in a direction indicated by arrow Z1, and the fabrication stage 24 of the fabrication chamber 22 moves downward in a direction indicated by arrow Z2.

At this time, a downward movement distance of the fabrication stage 24 is set so that a distance between a surface of a powder layer of the fabrication chamber 22 and a lower portion (lower tangential portion) of the flattening roller 12 is Δt1. The distance Δt1 corresponds to the thickness of the powder layer to be formed next. The distance Δt1 is preferably about 50 μm to about 300 μm, and for example, is set to about 150 μm in this embodiment.

Next, as illustrated in FIG. 6B, by moving the flattening roller 12 toward the fabrication chamber 22 (indicated by arrow X1) while rotating the flattening roller 12 in the reverse direction, powder 20 upper than the level of a top face of the supply chamber 21 is transferred and supplied to the fabrication chamber 22 (powder supply).

As illustrated in FIG. 6C, the flattening roller 12 is moved in parallel to the stage surface of the fabrication stage 24 of the fabrication chamber 22 (as indicated by arrow X1), and a powder layer 31 having a thickness of Δt1 is formed on the fabrication layer 30 of the fabrication stage 24 (flattening). After the powder layer is formed, as illustrated in FIG. 6D, the flattening roller 12 is moved in a direction indicated by arrow X2 and returned to an initial position.

Here, the flattening roller 12 is movable while maintaining a constant distance between the fabrication chamber 22 and the level of the top face of the supply chamber 21. Such a configuration allows formation of a uniform thickness Δt1 of the powder layer 31 on the fabrication chamber 22 or the fabrication layer 30 already formed while transporting the powder 20 to an area above the fabrication chamber 22 with the flattening roller 12.

Thus, after the flattening step (FIG. 6C) is conducted, the process shifts to a densification step (powder pressing step).

In other words, as illustrated in FIG. 7A, the fabrication stage 24 of the fabrication chamber 22 is moved upward in the direction indicated by arrow Z1. At this time, an upward movement distance of the fabrication stage 24 is set so that a distance between a surface of a powder layer of the fabrication chamber 22 and a lower portion (lower tangential portion) of the flattening roller 12 is Δt2. The distance Δt2 is preferably about 50 μm to about 100 μm, and for example, is set to about 50 μm in this embodiment.

The thickness Δt1 of the powder layer 31 is decreased by the distance Δt2 so that the thickness Δt of the first fabrication layer 30 is set to a value of Δt1-Δt2. In other words, the value of Δt1-Δt2 corresponds to a lamination pitch of the first fabrication layer 30.

As illustrated in FIG. 7B, while being rotated in the forward direction, the flattening roller 12 is moved in parallel to the stage surface of the fabrication stage 24 of the fabrication chamber 22 (as indicated by arrow X1) to press the powder layer 31 on the fabrication stage 24 (powder pressing or densification). As described above, the flattening roller 12 is horizontally moved while being rotated in the direction opposite the counter direction, thus obtaining effects of increase of the density of powder.

Next, after the flattening roller 12 is returned toward the supply chamber 21, as illustrated in FIG. 7C, the flattening roller 12, while being rotated in the forward direction, is moved again in parallel to the stage surface of the fabrication stage 24 of the fabrication chamber 22 (as indicated by arrow X1). Thus, the flattening roller 12 flattens the surface of the powder layer 31 pressed on the fabrication stage 24 again (flattening).

Then, as illustrated in FIG. 7D, fabrication liquid 10 is discharged from a head 51a of the discharge head unit 51 to form multilayers of the fabrication layer 30 of the thickness of Δt.

For the fabrication layer 30, for example, when the fabrication liquid 10 discharged from the head 51a is mixed with the powder 20, adhesives contained in the powder 20 dissolve and bond together. Thus, particles of the powder 20 bind together to form the fabrication layer 30.

Next, the above-described powder supply and flattening steps and the step of discharging the fabrication liquid with the head are repeated to form a new fabrication layer. At this time, a new fabrication layer and a fabrication layer below the new fabrication layer are united to form part of a three-dimensional fabrication object.

Then, the powder supply and flattening steps and the step of discharging the fabrication liquid with the head are repeated a required number of times to finish the three-dimensional fabrication object (solid fabrication object).

Next, descriptions are given of a powder material (powder) for three-dimensional fabrication and a fabrication liquid used in a three-dimensional fabricating apparatus according to an embodiment of this disclosure.

The powder material for three-dimensional fabrication includes a base material and a water-soluble organic material that dissolves by action of cross-linker containing water serving as fabrication liquid and turns to be cross-linkable. The base material is coated with the water-soluble organic material at an average thickness of 5 nm to 500 nm.

For the powder material for three-dimensional fabrication, the water-soluble organic material coating the base material dissolves by action of cross-linker containing water and turns to be cross-linkable. When cross-linker containing water is applied to the water-soluble organic material, the water-soluble organic material dissolves and cross-link by action of cross-linkers contained in the cross-linker containing water.

Thus, a thin layer (powder layer) is formed with the powder material for three-dimensional fabrication. When the cross-linker containing water is discharged as the fabrication liquid 10 onto the powder layer, the dissolved water-soluble organic material cross-links in the powder layer. As a result, the powder layer is bound and hardened, thus forming the fabrication layer 30.

At this time, the coverage of the water-soluble organic material coating the base material is 5 nm to 500 nm in average thickness. When the water-soluble organic material dissolves, only a minimum required amount of the water-soluble organic material is present around the base material. The minimum required amount of water-soluble organic material cross-links and forms a three-dimensional network. Accordingly, the powder layer is hardened at a good dimensional accuracy and strength.

Repeating the operation allows a complex three-dimensional object to be simply and effectively formed at a good dimensional accuracy without losing the shape before sintering.

The three-dimensional object thus obtained has a good hardness. Even if the three-dimensional object is held by hand or an excess powder material for three-dimensional fabrication is removed by air blowing, the three-dimensional object is free from losing the shape and then can be easily sintered.

In the three-dimensional object formed as described above, the base material is present densely (at a relatively high packing density). A quite small amount of the water-soluble organic material is present between the base materials. Then, when a molded object (three-dimensional object) is obtained by sintering and so on, the molded object is free from unnecessary voids and a good-appearance molded object (three-dimensional object) can be obtained.

—Base Material—

The base material is not limited to a specific material as long as the material has a shape of powder or particle. Any powder or particulate material can be selected as the base material according to the purpose. Examples of the material include metal, ceramic, carbon, polymer, wood, and biocompatible material. From a viewpoint of obtaining a relatively high strength of three-dimensional object, for example, metal or ceramic which can be finally sintered is preferable.

Preferable examples of metal include stainless steel (SUS), iron, copper, titan, and silver. An example of SUS is SUS316L.

Examples of ceramic include metal oxide, such as silica (SiO₂), alumina (AL₂O₃), zirconia (ZrO₂), and titania (TiO₂).

Examples of carbon include graphite, graphene, carbon nanotube, carbon nanohorn, and fullerene.

An example of polymer is publicly-known water-insoluble resin.

Examples of wood include woodchip and cellulose.

Examples of biocompatible material includes polylactic acid and calcium phosphate.

Of such materials, one material can be solely used or two or more types of materials can be used together.

In at least one embodiment of this disclosure, commercially available particles or powder formed of such materials can be used as the base material. Examples of commercial products include SUS316L (PSS316L made by SANYO SPECIAL STEEL Co., Ltd), SiO₂ (Ecserica SE-15 made by Tokuyama Corporation), ZrO₂ (TZ-B53 made by Tohsoh Corporation).

To enhance the compatibility with water-soluble organic material, known surface (reforming) treatment may be performed on the base material.

—Water-Soluble Organic Material—

The water-soluble organic material is not limited to a specific material as long as the material dissolves in water and is cross-linkable by action of cross-linker. In other words, if it is water-soluble and water-linkable by action of cross-linker, any material can be selected according to the purpose.

Here, the water solubility of water-soluble organic material means that, when a water-soluble organic material of 1 g is mixed into water 100 g at 30° C. and stirred, not less than 90 mass percentage of the water-soluble organic material dissolves in the water.

As the water-soluble organic material, the viscosity of four mass percentage (w/w %) solution at 20° C. is preferably not greater than 40 mP·s, more preferably 1 to 35 P·s, particularly more 5 to 30 Pa·s.

When the viscosity of the water-soluble organic material is greater than 40 mP·s, the hardness of a hardened material (three-dimensional object or hardened material for sintering) of the powder material (powder layer) for three-dimensional object formed by applying cross-linker containing water to the powder material for three-dimensional fabrication may be insufficient. As a result, in post-treatment, such as sintering, and handling, the hardened material may lose the shape. In addition, the hardened material may be insufficient in dimensional accuracy.

The viscosity of the water-soluble organic material can be measured in accordance with, for example, JISK117.

—Cross-Linker Containing Water—

The cross-linker containing water serving as fabrication liquid is not limited to any specific liquid as long as the liquid contains cross linker in aqueous medium, and any suitable liquid is selectable according to the purpose. The cross-linker containing water can include any other suitable component as needed in addition to the aqueous medium and the cross-linker.

As such other component, any suitable component is selectable in consideration of conditions, such as the type of an applicator of the cross-linker containing water or the frequency and amount of use. For example, when the cross-linker containing water is applied according to a liquid discharge method, a component can be selected in consideration with influences of clogging to nozzles of the liquid discharge head.

Examples of the aqueous medium include alcohol, ethanol, ether, ketone, and preferably water. The aqueous medium may be water containing a slight amount of other component, such as alcohol, than water.

Using the above-described powder material for three-dimensional object and cross-linker containing water serving as fabrication liquid reduces clogging of nozzles and enhances the durability of the liquid discharge head as compared to a configuration in which the liquid discharge head discharges binder to attach powder (base material).

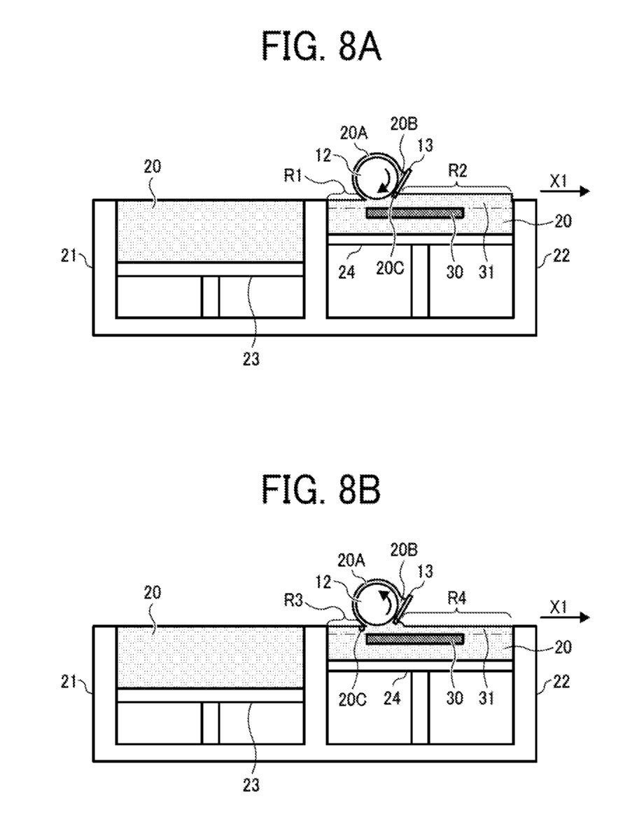

Next, an example of reduction in flatness of the powder layer 31 due to falling of aggregated powder in the densification step or the flattening step is described with reference to FIGS. 8A and 8B. FIGS. 8A and 8B are illustrations of an example of reduction in flatness of the powder layer 31.

In the densification step, as illustrated in FIG. 8A, since the flattening roller 12 is rotated in the forward direction, powder 20A attached to a circumferential surface of the flattening roller 12 is stopped by the powder removal plate 13 to aggregate together. Such aggregated powder 20B passes through between the circumferential surface of the flattening roller 12 and the powder removal plate 13 and falls onto a pressed region R1 in a lump 20C. (In FIG. 8A, R2 represents an unpressed region.)

As illustrated in FIG. 8B, when the flattening step is conducted again after the densification step, the flattening roller 12 is rotated in the reverse direction and a portion of aggregated powder 20B falls onto a flattened region R3 in a lump 20C, thus reducing the flatness of the powder layer 31. (In FIG. 8B, R4 represents an unflattened region.)

Even when the densification step is not conducted, an edge of the powder removal plate 13 contacting the flattening roller 12 is worn by, e.g., abrasion. Accordingly, powder during flattening may pass through a clearance between the circumferential surface of the flattening roller 12 and the powder removal plate 13 and aggregate together. If such aggregated powder occurs, a portion of aggregated powder may fall onto a flattened region in a lump, thus reducing the flatness.

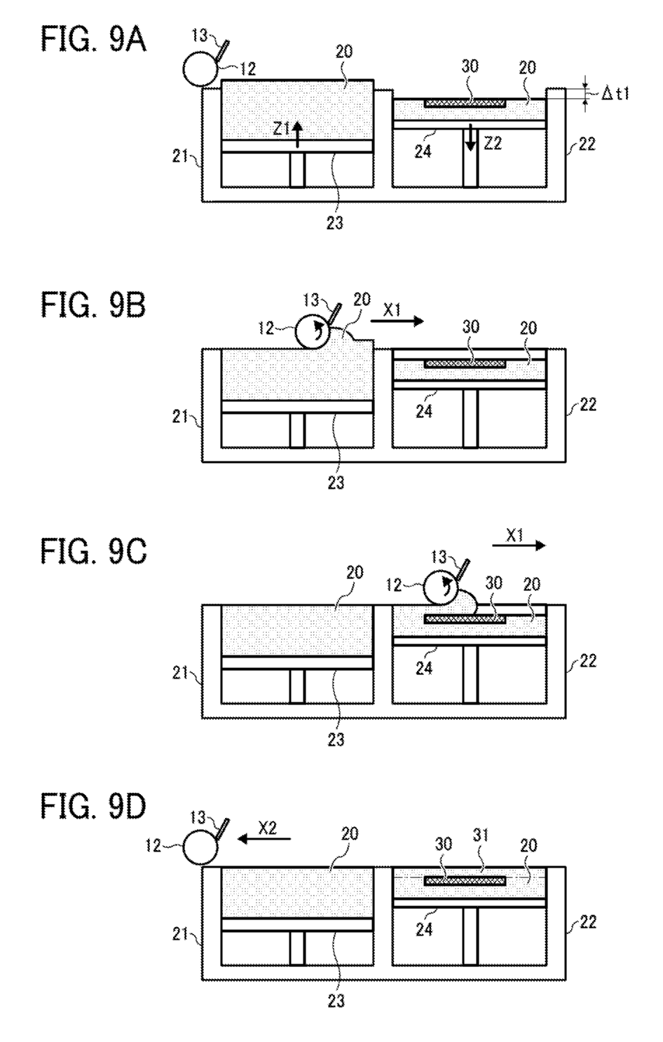

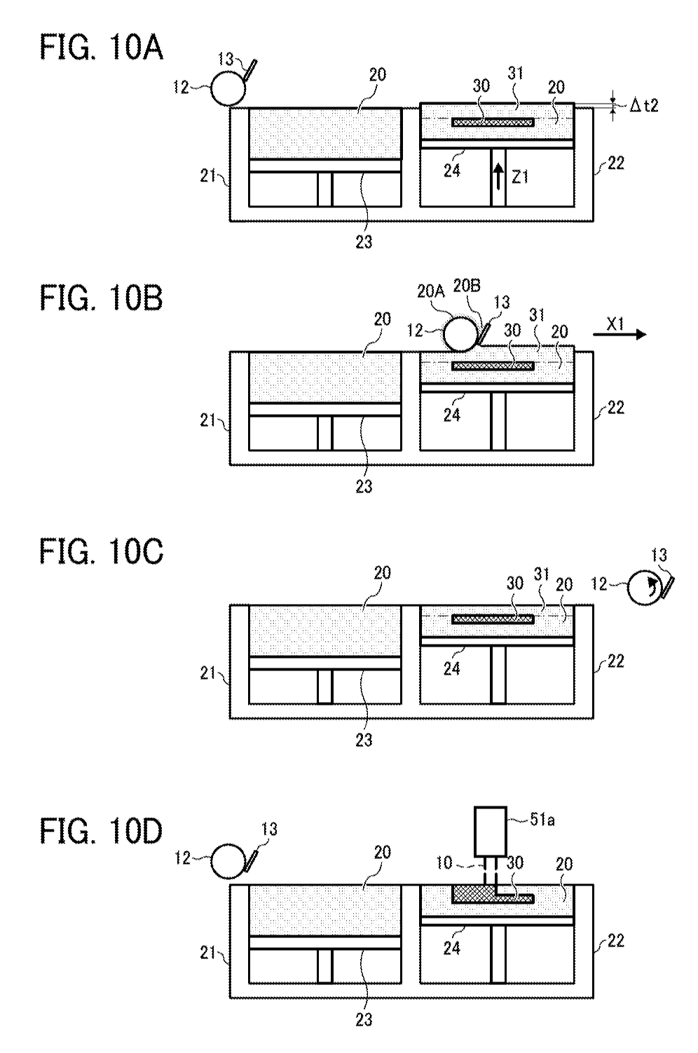

Next, a first embodiment of the present disclosure is described with reference to FIGS. 9A through 9D and 10A through 10D. FIGS. 9A through 9D are schematic cross-sectional views of fabrication steps of the fabrication section according to a first embodiment of this disclosure. FIGS. 10A through 10D are schematic cross-sectional views of steps subsequent to the fabrication steps illustrated in FIGS. 9A thorough 9D.

In this embodiment, a flattening step similar to the flattening step described with reference to FIGS. 6A through 6D. In other words, when a second fabrication layer 30 is formed on a first fabrication layer 30 as illustrated in FIGS. 9A thorough 9D, as illustrated in FIG. 9A, the supply stage 23 of the supply chamber 21 moves upward in the direction indicated by arrow Z1, and the fabrication stage 24 of the fabrication chamber 22 moves downward in the direction indicated by arrow Z2.

At this time, a downward movement distance of the fabrication stage 24 is set so that a distance between a surface of a powder layer 31 of the fabrication chamber 22 and a lower portion (lower tangential portion) of the flattening roller 12 is AU.

Next, as illustrated in FIG. 9B, by moving the flattening roller 12 toward the fabrication chamber 22 while rotating the flattening roller 12 in the reverse direction, powder 20 upper than the level of a top face of the supply chamber 21 is transferred and supplied to the fabrication chamber 22 (powder supply).

As illustrated in FIG. 9C, the flattening roller 12 is moved in parallel to the stage surface of the fabrication stage 24 of the fabrication chamber 22. As illustrated in FIG. 9D, a powder layer 31 having a thickness of AU is formed on the fabrication layer 30 of the fabrication stage 24 (flattening). After the powder layer is formed, the flattening roller 12 is moved in the direction indicated by arrow X2 and returned to an initial position.

Then, as illustrated in FIG. 10A, the fabrication stage 24 of the fabrication chamber 22 is moved upward in the direction indicated by arrow Z1. At this time, an upward movement distance of the fabrication stage 24 is set so that a distance between a surface of a powder layer of the fabrication chamber 22 and a lower portion (lower tangential portion) of the flattening roller 12 is Δt2.

As illustrated in FIG. 10B, while being rotated in the forward direction, the flattening roller 12 is moved in parallel to the stage surface of the fabrication stage 24 of the fabrication chamber 22 to press the powder layer 31 on the fabrication stage 24 (densification or powder pressing).

At this time, as described above, powder 20A attached by the rotation of the flattening roller 12 in the forward direction is transferred to between the circumferential surface of the flattening roller 12 and the powder removal plate 13, thus causing aggregated powder 20B.

Then, as illustrated in FIG. 10C, after the flattening roller 12 is moved to an ex-fabrication region outside the fabrication chamber 22, the flattening roller 12 is rotated in the reverse direction (which is a direction in which the flattening roller 12 is rotated for flattening).

Thus, aggregated powder 20B between the circumferential surface of the flattening roller 12 and the powder removal plate 13 is moved by the reverse direction rotation of the flattening roller 12 and scraped off by the powder removal plate 13 positioned in a direction to counter the reverse direction rotation of the flattening roller 12 (cleaning).

This embodiment is described with the example in which the flattening roller 12 is rotated in the reverse direction to clean powder. It is to be noted that a combination of the reverse direction rotation and the forward direction rotation may be conducted, such as a combination in which the flattening roller 12 is rotated in the reverse direction and then rotated in the forward direction.

Thus, powder aggregated between the circumferential surface of the flattening roller 12 and the powder removal plate 13 is cleaned and removed. Then, even when powder pressing or flattening is conducted, falling of aggregated powder is suppressed, thus suppressing reduction in the flatness.

As described above, the main controller 500A controls the movement of the flattening roller 12 and the powder removal plate 13 to the ex-fabrication region and the cleaning operation by the rotation of the flattening roller 12 in the reverse direction.

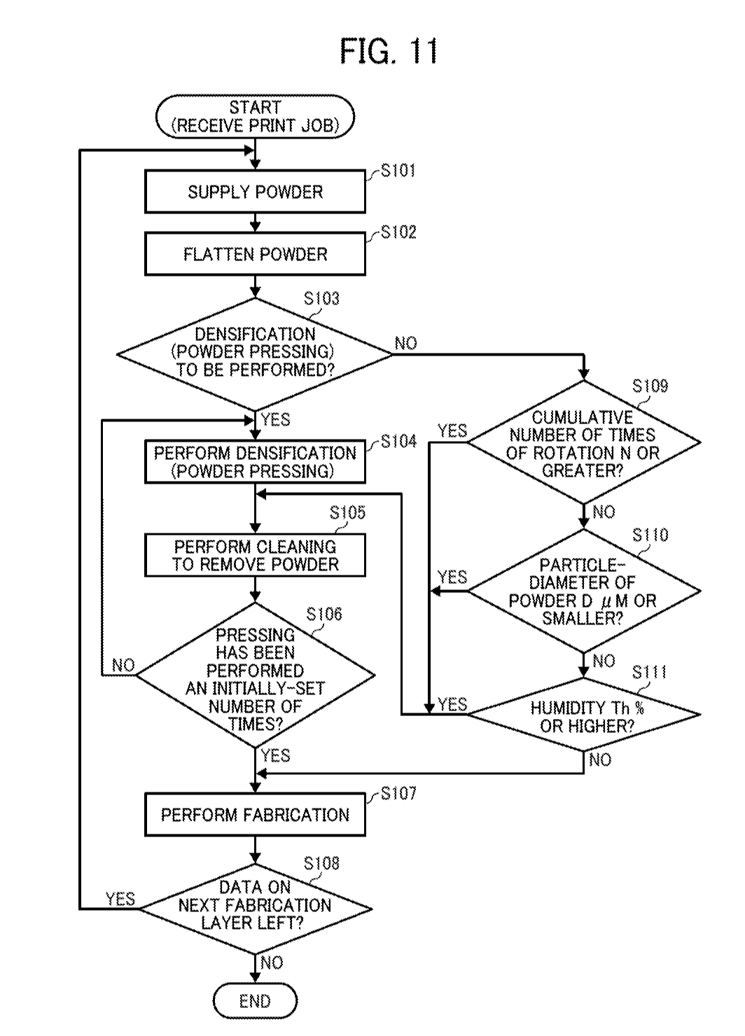

Next, a second embodiment of this disclosure is described with reference to FIG. 11. FIG. 11 is a flowchart of a fabrication process controlled by the main controller 500A in the second exemplary embodiment.

When the main controller 500A receives a print job from the fabrication data generating apparatus 600, as described above, the main controller 500A conducts powder supply to the fabrication chamber 22 (S101) and causes the flattening roller 12 to move to flatten powder while rotating the reverse direction (S102), thus forming a powder layer 31.

At S103, the main controller 500A determines whether densification (powder pressing) is to be performed.

Here, when densification (powder pressing) is to be performed (YES at S103), at S104 the main controller 500A causes the flattening roller 12 to move while rotating in the forward direction, thus performing the densification step (operation). At S105, the main controller 500A causes the flattening roller 12 to rotate in the reverse direction and thus performs the cleaning step (powder removal step) to remove aggregated powder accumulated between the circumferential surface of the flattening roller 12 and the powder removal plate 13.

At S106, the main controller 500A determines whether the densification operation has been performed an initially-set number of times of powder pressing. If the densification operation has not been performed the initially-set number of times (NO at S106), the process goes back to the step (S104) of the densification operation.

By contrast, if the densification operation has been performed the initially-set number of times (YES at S106), at S107 the main controller 500A causes the discharge head unit 51 to discharge fabrication liquid from the head 51a to form the fabrication layer 30, thus performing fabrication operation. At S108, the main controller 500A determines whether data on the next fabrication layer is left. If the data is left (YES at S108), the process goes back to the step (S101) of powder supply. By contrast, if the data is not left (NO at S108), the process ends.

Alternatively, if the densification operation is not performed (NO at S103), at S109 the main controller 500A determines whether the cumulative number of times of rotation of the flattening roller 12 is a threshold number N or greater. At S110, the main controller 500A determines whether the particle diameter of powder 20 is a threshold diameter D μm or smaller. At S111, the main controller 500A determines whether a humidity detected with the temperature-and-humidity sensor 560 is a threshold humidity Th (%) or higher.

For the determination of whether the particle diameter of powder 20 is a threshold diameter D or smaller, for example, the ROM 502 stores characteristic data, such as particle diameter and particle-diameter profile, for different types of powder in advance. The main controller 500A reads out characteristic data (e.g., material and particle diameter profile) corresponding to the type of powder 20 used for fabrication and determines whether the particle diameter of the powder 20 is a threshold diameter D or smaller.

At this time, when the cumulative number of times of rotation of the flattening roller 12 is the threshold number N or greater (YES at S109), when the particle diameter of the powder 20 is the threshold diameter D (μm) or smaller, or when the humidity detected with the temperature-and-humidity sensor 560 is the threshold humidity Th (%) or higher, the main controller 500A performs the cleaning step.

In other words, for this embodiment, after the flattening unit performs flattening of the powder layer or performs the densification operation, the main controller 500A performs the cleaning operation (powder removal operation) to clean the powder 20 accumulated between the flattening roller 12 and the powder removal plate 13.

The cleaning operation is performed in, e.g., a condition in which the powder 20 is likely to accumulate between the flattening roller 12 and the powder removal plate 13 and a condition in which powder is likely to aggregate.

In this embodiment, as described above, the main controller 500A determines whether to perform the cleaning operation based on, for example, 1) whether the densification operation is to be performed, 2) the duration of the apparatus (the cumulative number of times of rotation of the rotator), 3) the particle diameter of powder, and 4) the humidity environment in which the apparatus is used or stored.

As described above, the main controller 500A performs the cleaning operation in a condition in which the powder 20 is likely to accumulate between the flattening roller 12 and the powder removal plate 13 and a condition in which powder is likely to aggregate. Such a configuration reliably removes aggregated powder and more effectively suppress a reduction in productivity than a configuration in which cleaning operation is performed every time flattening operation is performed.

For example, when the densification operation is performed, the flattening roller 12 is rotated in the forward direction and the powder 20 is likely to accumulate between the flattening roller 12 and the powder removal plate 13. Accordingly, it is preferably to perform the cleaning operation.

Even when the densification operation is not performed, it is preferable to perform the cleaning step depending on the cumulative number of times of rotation of the flattening roller 12. In other words, as the flattening roller 12 rotates, to the surface of the flattening roller 12 may be partially worn by friction with the powder 20. The powder 20 is likely to adhere to such a worn portion. An edge of the powder removal plate 13 contacting the flattening roller 12 may also be worn by abrasion.

In such a case, the powder 20 to be removed by the powder removal plate 13 may not be removed and may aggregate together near a contact portion between the flattening roller 12 and the powder removal plate 13. Accordingly, it is preferable to perform the cleaning operation. The cumulative threshold number of times N of rotation of the flattening roller 12 at which the cleaning operation is to be performed is set to a different value according to, e.g., materials of the flattening roller 12 and the powder removal plate 13, and is set to, e.g., ten million times.

Alternatively, even when the densification operation is not performed, it is preferable to perform the cleaning operation depending on the particle diameter of the powder 20. As the particle diameter is smaller, the adhesion force between powder particles increases and the powder particles are likely to aggregate together and adhere to the circumferential surface of the flattening roller 12 and the powder removal plate 13.

Accordingly, as described above, powder may aggregate near the contact portion between the flattening roller 12 and the powder removal plate 13, and it is preferable to perform the cleaning operation. The threshold particle diameter D of powder at which the cleaning operation is to be performed is set to a different value according to the material of powder, and set to, e.g., 20 μm or smaller.

Alternatively, even when the densification operation is not performed, it is preferable to perform the cleaning operation depending on the humidity environment in which the apparatus is used or stored As the humidity environment in which the apparatus is used is higher, the adhesion force between powder particles also increases and the powder particles are likely to aggregate together and adhere to the circumferential surface of the flattening roller 12 and the powder removal plate 13.

Accordingly, as described above, powder may aggregate near the contact portion between the flattening roller 12 and the powder removal plate 13, and it is preferable to perform the cleaning operation. The threshold humidity Th of the stored or used environment of the apparatus at which the cleaning operation is to be performed is set to a different value according to the material of powder, and set to, e.g., 50% or higher.

In the cleaning operation, the flattening roller 12 is rotated in the same direction as the flattening direction which is opposite the direction in which the flattening roller 12 is rotated for densification (powder pressing). In other words, the flattening roller 12 can idle.

With such a configuration, rotation of the flattening roller 12 causes powder accumulating between the flattening roller 12 and the powder removal plate 13 to move out from between the flattening roller 12 and the powder removal plate 13, thus obtaining an effect of removing powder. Such a configuration also obviates an additional cleaning device and performs cleaning by only the rotation of the flattening roller 12, thus preventing an increase in cost and apparatus size due to such an additional component.

It is to be noted that, as described above, the rotation direction of the flattening roller 12 in the cleaning operation may be not only the direction opposite the direction in which the flattening roller 12 is rotated for densification (powder pressing) but also a combination of the reverse direction rotation and the forward direction rotation in which, e.g., the flattening roller 12 is rotated in the reverse direction and then rotated in the forward direction (alternatively, the reverse direction rotation and the forward direction rotation may be repeated a predetermined number of times).

It is also preferable to perform the cleaning operation in the ex-fabrication region outside the fabrication stage 24. Such a configuration prevents falling of removed powder onto the fabrication region, thus preventing a reduction in the flatness of the powder layer.

In other words, when the cleaning operation is performed, for example, a receiver may be interposed between the flattening roller 12 and the fabrication stage 24 to receive powder removed by the cleaning operation. Such a configuration allows the cleaning operation to be performed on the fabrication stage 24. However, for such a configuration, a retraction mechanism is also provided to retract the receiver when the flattening roller 12 transfers or densifies powder. Accordingly, in this embodiment, the cleaning operation is performed in the ex-fabrication region, thus allowing the cleaning operation to be performed without such a retraction mechanism.

When the apparatus is left unused for a long time or suddenly shut down during the densification operation (powder pressing operation), it is preferable to perform the cleaning operation in advance of flattening after the apparatus is powered on.

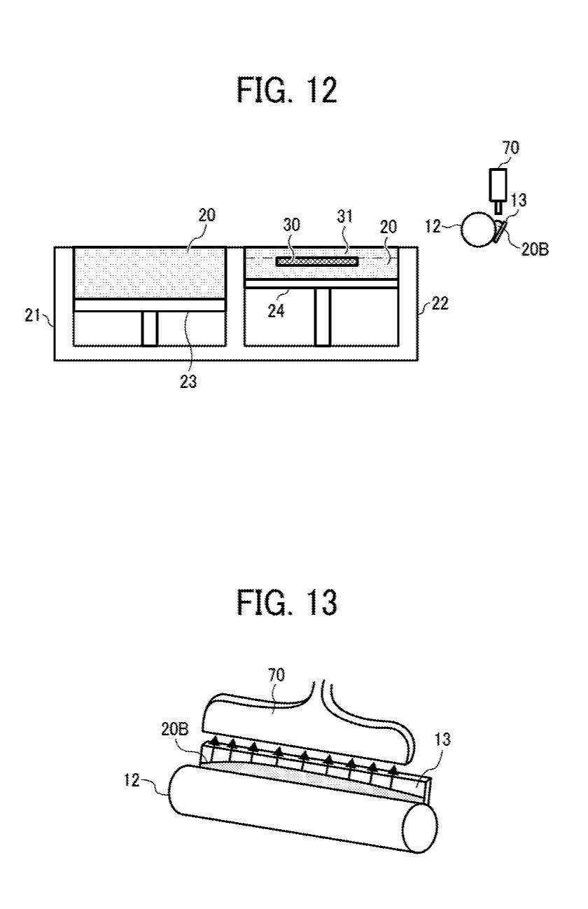

Next, a third embodiment of the present disclosure is described with reference to FIGS. 12 and 13. FIG. 12 is a schematic cross-sectional view of cleaning operation of a fabrication section in the third embodiment. FIG. 13 is a perspective view of a portion of the fabrication section of FIG. 12.

For this embodiment, the fabrication section includes a suction device 70 to suck powder 20 and aggregated powder 20B accumulated between a flattening roller 12 and a powder removal plate 13. The suction device 70 has substantially the same width as that of the flattening roller 12 and is connected to a suction pump.

To perform cleaning operation, the suction device 70 approaches between the flattening roller 12 and the powder removal plate 13 and performs sucking operation to suck and remove powder 20 and aggregated powder 20B accumulated between the flattening roller 12 and the powder removal plate 13.

In such a case, as described in the above-described first and second embodiments, the flattening roller 12 may be rotated during the sucking operation. In other words, when the flattening roller 12 is rotated to perform the cleaning operation in the above-described first and second embodiments, the suction device 70 may simultaneously perform sucking operation.

As the sucking device, for example, a sucking device used to remove unbonded powder remaining after a fabrication object is taken out of a fabrication chamber 22 may be utilized. Such a configuration obviates an additional suction device.

For this embodiment, even when the cleaning operation is performed above a fabrication stage 24, powder removed by the suction device 70 does not fall onto the fabrication stage 24. Accordingly, the cleaning operation can be performed above the fabrication stage 24. The cleaning operation can be performed in the ex-fabrication region as well.

Next, a fourth embodiment of this disclosure is described with reference to FIG. 14. FIG. 14 is a schematic cross-sectional view of cleaning operation of a fabrication section in the fourth embodiment.

For this embodiment, a powder removal plate 13 is disposed to be contactable with and separatable from a circumferential surface of a flattening roller 12.

In the cleaning operation, as illustrated in FIG. 14, the powder removal plate 13 is separated from the circumferential surface of the flattening roller 12. In such a state, a cleaner 71 wipes or scrapes powder adhering to, e.g., the circumferential surface of the flattening roller 12.

As the cleaner 71, for example, a wiper or a brush movable in an axial direction of the flattening roller 12.

In such a case, the entire circumferential surface can be cleaned by rotating the flattening roller 12.

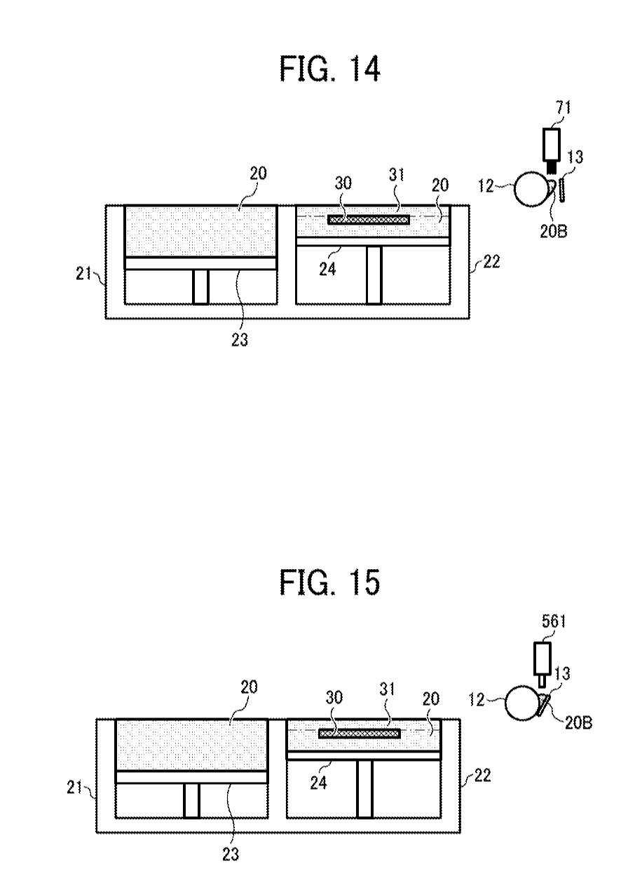

Next, a fifth embodiment of this disclosure is described with reference to FIG. 15. FIG. 15 is a schematic cross-sectional view of cleaning operation of a fabrication section in the fourth embodiment.

For this embodiment, the fabrication section includes an aggregation sensor 561 to detect powder 20 accumulated between a flattening roller 12 and a powder removal plate 13.

Based on detection results of the powder 20 with the aggregation sensor 561, the main controller 500A controls cleaning operation only when aggregated powder 20B is detected. As the aggregation sensor 561, for example, a laser displacement gauge or a photosensor may be used.

Such a configuration more effectively suppress a reduction in productivity than a configuration in which the cleaning operation is performed each time flattening is performed. Note that it is preferable to detect powder with the aggregation sensor in an ex-fabrication region. To maintain the accuracy of detection, it is also preferable to cover the aggregation sensor with a cover when the detection is not needed, so that scattered powder does not attach the aggregation sensor.

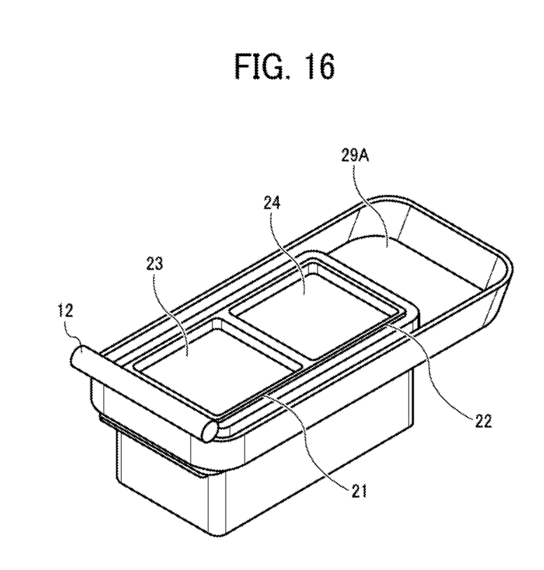

Next, a sixth embodiment of this disclosure is described with reference to FIG. 16. FIG. 16 is a perspective view of a powder chamber in the sixth embodiment.

For this embodiment, a powder chamber 11 includes a supply chamber 21, a fabrication chamber 22, and an excessive powder receive portion 29A to receive powder 20 not used for formation of a powder layer 31.

Then, when the above-described cleaning operation of a flattening roller 12 is performed in an ex-fabrication region outside a fabrication stage 24, the cleaning operation is performed with the flattening roller 12 placed on the excessive powder receive portion 29A.

Such a configuration allows powder 20 removed by the cleaning operation to be stored in the excessive powder receive portion 29A.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A three-dimensional fabricating apparatus, comprising:
a fabrication stage on which fabrication layers including powder bonded together are to be laminated;
a rotator to rotate and move relatively with respect to the fabrication stage in a direction along a stage surface of the fabrication stage to flatten a surface of the powder on the fabrication stage and form a powder layer,
a powder remover to contact a circumferential surface of the rotator and remove the powder adhering to the circumferential surface of the rotator; and
a cleaning controller operatively connected to the rotator to control a cleaning operation to rotate the rotator and clean the powder accumulated between the circumferential surface of the rotator and the powder remover.

2. The three-dimensional fabricating apparatus according to claim 1, wherein, where a direction in which the rotator rotates to flatten the surface of the powder on the fabrication stage is a forward direction, in the cleaning operation, the cleaning controller causes the rotator to rotate in a reverse direction opposite the forward direction.

3. The three-dimensional fabricating apparatus according to claim 1, wherein, where a direction in which the rotator rotates to flatten the surface of the powder on the fabrication stage is a forward direction, in the cleaning operation, the cleaning controller causes the rotator to rotate in a reverse direction opposite the forward direction and then rotate in the forward direction.

4. The three-dimensional fabricating apparatus according to claim 1, further comprising a sensor to detect the powder accumulated between the circumferential surface of the rotator and the powder remover,
wherein the cleaning controller performs the cleaning operation based on a detection result of the sensor.

5. The three-dimensional fabricating apparatus according to claim 1, wherein the cleaning controller performs the cleaning operation based on whether a densification operation to press the powder flattened by the rotator is to be performed.

6. The three-dimensional fabricating apparatus according to claim 1, wherein the cleaning controller determines whether the cleaning operation is to be performed, based on at least one of whether a densification operation to press the powder flattened by the rotator is to be performed, a cumulative number of times of rotation of the rotator, a particle diameter of powder, and humidity environment in which the three-dimensional fabricating apparatus is used.

7. The three-dimensional fabricating apparatus according to claim 1, further comprising a suction device to suck the powder accumulated between the circumferential surface of the rotator and the powder remover,
wherein, in performing the cleaning operation, the cleaning controller performs a suction operation to cause the suction device to suck the powder.

8. The three-dimensional fabricating apparatus according to claim 1, wherein the cleaning controller controls the cleaning operation to be performed in an ex-fabrication region outside the fabrication stage.

9. A three-dimensional fabricating apparatus, comprising:
a fabrication stage on which fabrication layers including powder bonded together are to be laminated;
a rotator to rotate and move relatively with respect to the fabrication stage in a direction along a stage surface of the fabrication stage to flatten a surface of the powder on the fabrication stage and form a powder layer,
a powder remover to contact a circumferential surface of the rotator and remove the powder adhering to the circumferential surface of the rotator;
a suction device to suck the powder accumulated between the circumferential surface of the rotator and the powder remover; and
a cleaning controller operatively connected to the suction device to control a cleaning operation to suck the powder with the suction device.

10. The three-dimensional fabricating apparatus according to claim 9, wherein the cleaning controller controls the cleaning operation to be performed in an ex-fabrication region outside the fabrication stage.

11. A three-dimensional fabricating apparatus, comprising:
a fabrication stage on which fabrication layers including powder bonded together are to be laminated;
a rotator to rotate and move relatively with respect to the fabrication stage in a direction along a stage surface of the fabrication stage to flatten a surface of the powder on the fabrication stage and form a powder layer,
a powder remover to contact a circumferential surface of the rotator and remove the powder adhering to the circumferential surface of the rotator, the powder remover contactable with and separatable from the circumferential surface of the rotator and including a cleaner to remove the powder adhering to the circumferential surface of the rotator; and
a cleaning controller operatively connected to the powder remover to control a cleaning operation to remove the powder adhering to the circumferential surface of the rotator with the cleaner in a state in which the powder remover is separated from the circumferential surface of the rotator.

12. The three-dimensional fabricating apparatus according to claim 11, wherein the cleaning controller controls the cleaning operation to be performed in an ex-fabrication region outside the fabrication stage.
